(19) United States
(12) Patent Application Publication
(10) Pub. No.: US 2010/0126588 A1
(43) Pub. Date: May 27, 2010

(54) PROGRAMMED INTERMITTENT AUTOMATIC WATERING SYSTEM

(76) Inventor: René Jeanrot, Olivet (FR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/438,962

(22) PCT Filed: Sep. 21, 2007
(86) PCT No.: PCT/FR07/01548

§ 371 Date: Dec. 14, 2009

(30) Foreign Application Priority Data
Sep. 22, 2006 (FR) 0608324

(51) Int. Cl. A01K 7/02; F16K 31/48

(52) U.S. Cl. 137/1; 119/72.5; 137/624.11

(57) ABSTRACT

A system intermittently feeding liquid to animal cages has a duct feeding liquid to liquid dispensers for the animals. Each dispenser includes: a lower portion with a liquid dispensing pipette for supplying liquid to the animals, an upper portion having a liquid flow rate adjuster in fluid flow relationship with liquid in the duct, and a buffer between the pipette and flow rate adjuster. The duct includes a valve responsive to a signal so that, during normal operation, with animals in the cages, the valve intermittently feeds liquid in the duct to the dispensers. The volume of liquid fed via the duct to the dispensers during each intermittent liquid feed depends on: time interval between adjacent feeds, flow rates of the flow rate adjusters, volumes of the buffers, and the buffers never being filled with the liquid so an airspace is always in the buffers.

### RELATED APPLICATIONS

The present application is based on, and claims priority from, FR Application Number 0608324, filed Sep. 22, 2006, and PCT Application Number PCT/FR07/001548, filed Sep. 21, 2007, the disclosures of which are hereby incorporated by reference herein in their entireties.

### FIELD OF INVENTION

The present invention relates to an automatic watering system for animals. Such systems are used in animal breeding farms and animal care houses, notably laboratory animal care houses, where the large number of animals makes automatic watering absolutely necessary.

### BACKGROUND ART

A problem in this field relates to the amount of liquid (generally water) to be distributed to the animals per watering point, this amount depending on the variable number of animals present in the different cages to be fed, on the type of animals and on their weight. Water distribution systems for pigeons including a solenoid coil controlling the emptying, rinsing and filling of a reservoir with fresh water are known from the prior art, notably from application GB 2,422,284 A. This type of system has the drawback of not providing sufficient flexibility as to the distributed volumes, of only delivering a determined amount of water to a single reservoir common to several animals, without allowing the distribution rate to be adjusted.

Another problem relates to the sterility of the watering network which should be observed in order to avoid epidemics. Various types of automatic watering systems are known from the prior art including a common feeding conduit to which several watering pipettes are connected with pressurized to water, one for each animal or group of animals. These pipettes are provided with an internal counterweight, or any other system (a float, joint and spring, etc.) which is used for automatically blocking the pipette when the latter is not actuated by an animal. The conduit is permanently fed and a feeding network may thereby be achieved for a large number of animals. The animal triggers the opening of the pipette (which plays the role of a valve here) and directly consumes the water at the conduit. These solutions have many drawbacks. On the one hand, possible leaks on the water network lead to excessive wasting of water and possibly, in certain types of watering, when the leak at the pipette is significant, it may cause flooding of the cages and drowning of the animals. On the other hand, the amount of water distributed by this type of system cannot be controlled and the difficulty of adjusting the seal of the pipette (most often by joint and spring) often makes watering impossible for young animals. Finally, the direct connection of the pipette on the feeding network of these systems generates a risk of contamination of the feeding network by regurgitation of the animals.

An automatic watering device is also known from the prior art, notably by French patent application No. 0309966 filed by the applicant, including a buffer space interposed between the pipette and the conduit, and an air space communicating with the outside of the device and interposed between the conduit and the buffer space in order to avoid risks of contaminating the water distribution network by the pipettes. This device, which therefore allows water to be delivered under atmospheric pressure to the animals, is directly connected to a conduit and includes an adjustment device with which the feeding rate of the buffer space with liquid may be adjusted. Further, the communication of the air space with the outside allows water to be discharged out of the device and optionally towards the outside of the cage in the case of misadjustment of the adjustment device or blocking of the pipettes. However, this device has the drawback of having a risk of waste if this misadjustment and blocking were to occur. On the other hand, adjusting of the adjustment device is not necessarily easy depending on the number and/or on the type of animals present in the different cages fed by the device. Further, this device has the drawback of including a pipette which has a risk of leaking and which is not universal in the sense that it is not adapted to all types and all ages of animals. Finally, with this type of device, the periods of the day during which water will be delivered, cannot be determined beforehand.

A last problem in the field of automatic watering systems for animals relates to the fact that the pipettes are often the cause of leaks and floods, for example because of the fact that the animals when drinking deposit foreign bodies (such as for example pieces of food or litter) inside the end of the pipette which then remains open. Thus, even the most elaborate pipettes may cause floods in the cages because of the fact that drops fall inside the cage.

### SUMMARY OF THE INVENTION

The present invention mainly proposes solving the problems of flexibility in the distributed volumes of water and of safety of the animals with regard to contaminations and floods. An object of the present invention therefore is to remedy certain drawbacks of the prior art by providing a programmed automatic intermittent watering system having great flexibility in the volumes distributed to the different cages fed by the system, suppression of the risks of contaminating the feeding network, suppression of the risks of waste, determination of the periods of the day during which water is delivered and including a universal pipette adapted to animals of all kinds and all ages, limiting the risks of leaking and clogging and avoiding flooding of the cages in the case of leaks.

This aim is reached by a programmed intermittent automatic watering system for feeding liquid to at least one cage or set of cages, including at least one duct for feeding with liquid to at least one automatic watering device for animals, the watering device comprising a watering pipette accessible to the animals, a buffer area interposed between the pipette and the duct and a flow rate adjustment means interposed between the duct and to the buffer area, means of the buffer area providing by an air space communicating with the outside of the device, a discontinuity between the volume of liquid contained in the buffer area and the liquid contained in the duct, the duct including at least one solenoid valve controlled by at least one programmer generating, for opening and/or closing the solenoid valve, pulses is at programmed intervals and durations depending on the volume of the buffer area and on a range of flow rates of the flow rate adjustment means of each of the watering devices, the flow rate adjustment means and the opening times of the solenoid valves being adapted to each other depending on the maximum amount of liquid to be delivered, and adjusted for delivering a determined amount of liquid to each of the watering devices upon each opening of the solenoid valve, the buffer area of the watering devices having a volume larger than the determined amount.

According to another particular feature, the programmer includes input and display means for programming/checking the durations and intervals of the pulses.

According to another particular feature, the programmer includes display resources for checking the durations and intervals of the programmed pulses.

According to another particular feature, the buffer area includes a means for maintaining the level of liquid of the buffer area below a threshold, regardless of the adjusted flow rate.

According to another particular feature, the means for maintaining the level of liquid of the buffer area below a threshold, is a nozzle made on the casing of the watering device, located above the buffer area and at a determined distance from the lower orifice, depending on the desired useful volume for the buffer area, this nozzle also forming the communication of the air space with the outside of the watering device allowing the buffer area to be at atmospheric pressure and allowing discharge of the liquid towards the outside in the case of overfill of the buffer area.

According to another particular feature, the means for adjusting the flow rate entering the buffer area is embodied by a needle valve screwed into a tapped hole bored on the outer surface of the buffer area and opening out into an inlet conduit of the watering device through which the liquid opens out into the buffer area, the needle valve being provided with a seal gasket and totally or partly blocking this inlet conduit.

According to another particular feature, the means for adjusting the flow rate entering the buffer area is embodied by an adjustment device with membranes, including at least one passage for the fluid in which at least two membranes are placed, at least one of which is mobile and displaceable in the direction of the other one under the action of an adjustment screw accessible from the outside, so as to more or less block said passage opening out into an inlet conduit of the watering device through which the liquid opens out into the buffer area.

According to another particular feature, the membranes of the adjustment device with membranes are flexible, so as to provide fine adjustment of the flow rate.

According to another particular feature, the pipette includes a body comprising two ends, one first end of which is formed by an inlet tube opening out on a main tube, the inner diameter of which is larger than that of the inlet tube, the shoulder between both of these tubes thereby forming a seat on which a spring is positioned, pushing back a ball towards the second end of the pipette, the ball and spring being free in the main tube and having dimensions substantially identical with those of the main tube, the second end of the pipette including a housing, a so-called ball seat, with shape and dimensions mating those of the ball, opening out onto the outside and in which the ball is held by the spring.

According to another particular feature, the ball seat is attached onto the main tube of the pipette by cooperation between a thread of the main tube and a tapped thread of the ball seat or vice versa.

According to another particular feature, the inner diameters of the inlet tube of the pipette and of the aperture of the ball seat towards the outside have substantially the same dimensions.

According to another particular feature, the watering device includes, in proximity to its upper end, an upper inlet conduit for the liquid which may be blocked by the flow rate adjuster and which is provided with resources for attachment and connection to the duct.

According to another particular feature, a filter is interposed between the duct and the watering device, so that the liquid penetrating into the buffer area of the watering device is filtered.

According to another particular feature, an anti-return system is interposed between the duct and the watering device in order to maintain pressure in the duct and avoids its emptying.

According to another particular feature, the filter is an absolute filter, so that the liquid penetrating in the buffer area of the watering device is sterile.

According to another particular feature, the resources for connection and attaching the watering device to the duct is a tube threaded on its outer surface, extending the inlet conduit and intended to cooperate with a corresponding tapped hole present on the feeding duct.

According to another particular feature, the tube for attaching the watering device to the feeding duct forms with the longitudinal axis of the buffer area an angle comprised between 0° and 90°.

According to another particular feature, the tube for attaching the watering device to the feeding duct is positioned vertically, the watering device being then attached under the feeding duct.

According to another particular feature, the tube for attaching the watering device to the duct is positioned horizontally, the watering device being attached onto a side wall of the feeding duct.

According to another particular feature, the watering device includes in proximity to its lower end a lower conduit for outflow of the liquid, this lower conduit communicating with the pipette and including resources for attaching and connecting the watering pipette.

According to another particular feature, the resources for attaching and connecting the watering pipette consists in a tapped bore intended to cooperate with an inlet tube of the pipette, threaded on its outer surface, so as to allow attachment of the watering pipette onto the watering device.

According to another particular feature, the position of the watering pipette by the resources for attaching and connecting of the watering pipette is adapted to animal species to be watered.

According to another particular feature, the tapped bore is with a horizontal axis.

According to another particular feature, the tapped bore has a vertical axis.

According to another particular feature, the tapped bore has an oblique axis relatively to the longitudinal axis of the buffer area, both axes forming an angle between 0° and 90°.

According to another particular feature, the outer surface of the body of the pipette is frusto-conical, such that the diameter of the body at the second end of the body being smaller than its diameter at the first end.

According to another particular feature, the cage includes in its wall, a hole with a diameter substantially larger than the diameter of the body of the pipette and through which the latter penetrates into the cage.

According to another particular feature, a recovery device is positioned under the watering device.

According to another particular feature, the recovery device has a substantially funnel shape including a flared portion positioned under the watering device and a discharge end opening into a discharge pipe allowing liquid to be collected.

According to another particular feature, the flared portion of the recovery device has a diameter substantially larger than the dimensions of at least one lower end of the watering device.

According to another particular feature, the recovery device includes a gutter positioned under the watering device and having a slope relative to the horizontal and a lower end which opens into a discharge pipe allowing liquid to be collected.

According to another particular feature, the dimensions of the gutter are larger than the dimensions of at least one lower end of the watering device.

Other particularities and advantages of the present invention will be more clearly apparent upon reading the description hereafter, made with is reference to the appended drawings.

### BRIEF DESCRIPTION OF THE DRAWING

FIG. 1 is a rear view of a preferred embodiment of a system according to the invention,

FIG. 2 is a longitudinal sectional view of an embodiment of the watering device of the system of FIG. 1,

FIG. 3 is a longitudinal sectional view of an embodiment of the watering device of the system of FIG. 1,

FIG. 4 is a sectional view along a vertical plane of a portion of the watering system according to another embodiment of FIG. 1.

### DETAILED DESCRIPTION OF THE DRAWING

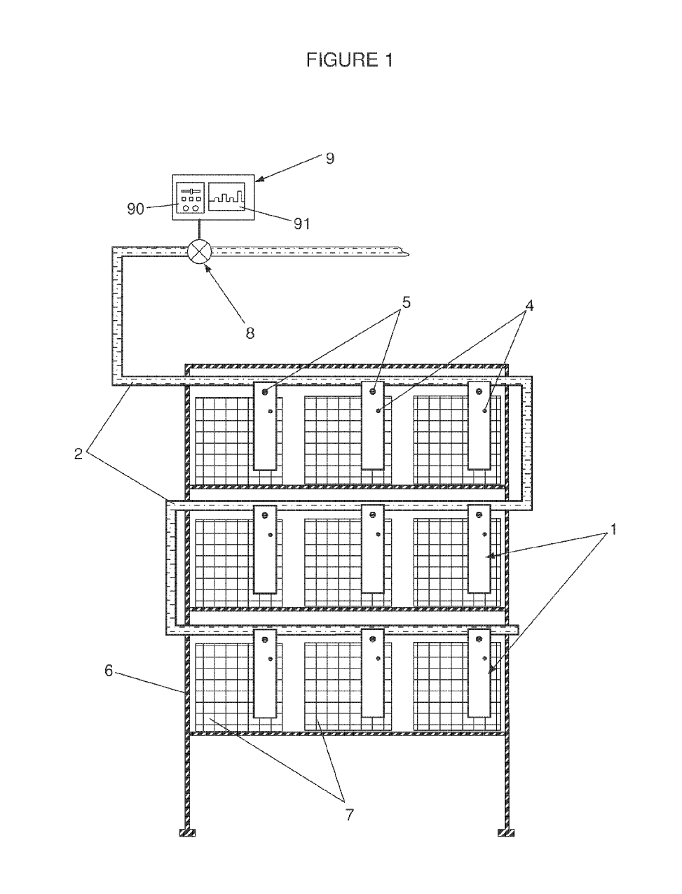

FIG. 1 relates to a programmed intermittent automatic watering system, for feeding liquid to at least one cage (7) or set (6) of cages (7), including a watering device (1) on which the animals come to drink. The system naturally includes at least one duct (2) from a collective network or a private network or from a reservoir depending on the quality and amount required. The liquid contained in the duct (2) is generally water but this may naturally be replaced by any type of liquid if necessary. The term <<water>> will therefore be used hereafter as an example. With the present system, a set (6) of cages (7) may be fed with water, for which the amounts of water to be daily delivered will have been determined beforehand. With the system, these amounts may be delivered automatically without requiring routine intervention of a person responsible for maintaining the cages. Also with the system, the delivered amounts may be distributed over several periods of the day without requiring intervention of a person during each of these periods and the delivered amounts may be varied according to the cages (depending on the number and/or on the kind of animals present therein) by a means (5) for adjusting the flow rate, present on each of the watering devices (1). Duct (2) is is provided with at least a solenoid valve (8) controlled by at least one programmer (9) generating pulses at programmed intervals and durations, for opening and/or closing the solenoid valve (8). The programmer is laid out for generating programmed pulses depending on the volume which may be stored in the watering devices (volume stored in a so-called buffer area of the device) and on a range of flow rates of the means for adjusting the flow rate (5) of each of the watering devices (1). Thus, the person in charge of the maintenance may program the periods of the day during which the animals should drink and program the opening time of the solenoid valve (8) depending on the amount which has to be delivered during each of these periods and depending on the capacity of the buffer area of the devices and on the flow rate range possessed by their flow rate adjustment means (5). Thus, the means for adjusting the flow rate (5) and the opening times of the solenoid valve are adapted to each other, depending on the maximum amount of liquid to be delivered, and are adjusted in order to deliver a determined amount of liquid to each of the watering devices (1) during each opening of the solenoid valve (8), the buffer area of the watering devices (1) may contain a larger volume than this determined amount. In one embodiment, the programmer (9) includes input means (90) for programming the durations and intervals of the pulses. In a possible alternative, the programmer is controlled by a computer system, such as for example a standard computer, on which the person in charge of the maintenance will program durations and intervals of the pulses for the different days, for example depending on the number of animals contained in each cage (7) for the days to come. In one embodiment, the programmer should be configured beforehand so that the person in charge of the maintenance only has to enter the volumes to be distributed for each of the cages (7) without caring about intervals and durations, or about corresponding calculations. The present invention provides different alternative embodiments as regards the programming of the programmer (9) controlling the opening and/or closing of the solenoid valve (8) and the alternative embodiments given here should be considered as illustrative and non-limiting because person skilled in the art is is aware of how to program a programmer (9) allowing different configurations which may be changed by the users. Also, the term “pulses” should be understood in the broad sense, the programmer optionally delivering different types of signals adapted to different types of solenoid valves.

In one embodiment, the programmer (9) includes display means (91) so that the person in charge of maintenance may check the entered parameters: durations of the pulses and time intervals between the pulses. Finally, the term “solenoid valve” may be extended to any type of remote-controlled valves and of solenoid valves reacting to different types of signals originating from the outside of the valve, whether they are electrical or not.

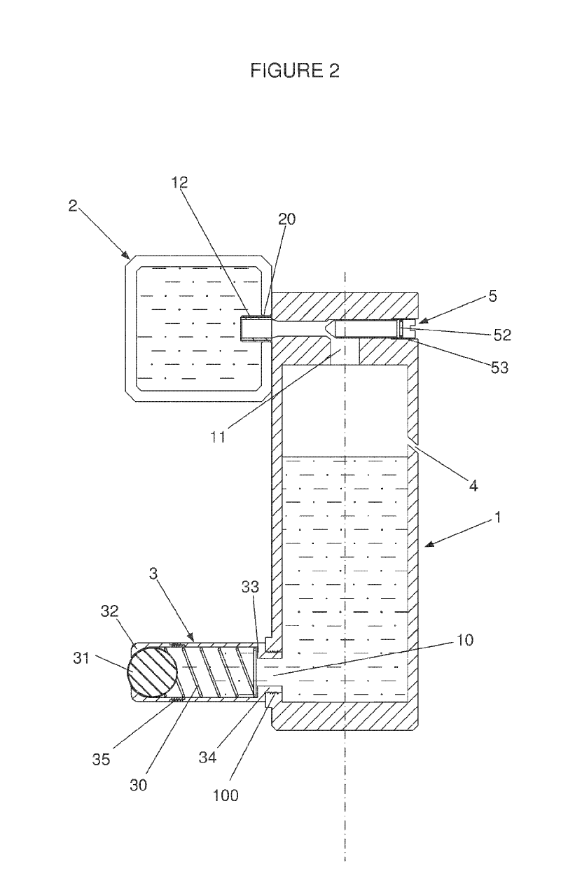

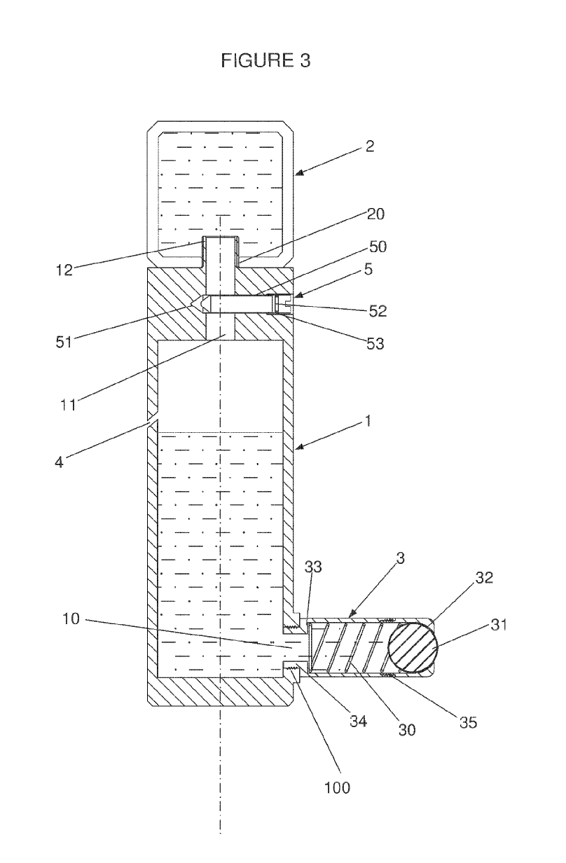

FIG. 1 is an overall view of the system feeding a set of cages (7) mounted on a rack (6), for example a rear view. This illustration is schematic and illustrative, the set (6) of cages (7) may naturally be supported by any device and have any arrangement, what is essential is that at least one duct (2) will feed the cages (7). Each of the cages (7) is equipped with an automatic watering device (1) for animals, particularly visible in FIGS. 2 and 3. The watering devices (1) are advantageously arranged outside the cages (7) but they may also be arranged inside because, with the system of FIG. 1, flooding of the cages (7) may be avoided, even in case of a leak, notably by means of the nozzle (4) and the optional pipe opening out outside the cages, as explained hereafter. Each of these watering devices (1) includes a watering pipette (3) within reach of the animals and a buffer area interposed between the pipette (3) and the duct (2). With this buffer area, the risks of contamination of the distribution network may be avoided during possible regurgitations of the animals in the watering device (1). Indeed, the buffer area is isolated from the remainder of the network by means of the buffer area providing, by an air space communicating with the outside of the device, a discontinuity between the volume of liquid contained in the buffer area and the liquid contained in the duct (2). Each of these watering devices (1) also includes a means for adjusting the flow rate (5) interposed between the duct (2) and the buffer area. This flow rate adjusting means (5) is adapted to the opening times of the solenoid valve depending on the maximum amount of is liquid to be delivered and adjusted in order to deliver a determined amount of liquid upon each opening of the solenoid valve (8), the duration of which is adapted to the flow rate range of the means (5) for adjusting the flow rate and to the volume of the buffer area (which may contain a greater volume than this determined amount). In one embodiment, the means of the buffer area providing discontinuity, consist in a nozzle (4) made on the casing of the watering device (1) located above the buffer area and at a determined distance from the lower orifice (10) depending on the desired useful volume for the buffer area. This nozzle (4) also forms the communication of the air space located above the buffer area with the outside of the watering device (1) and allows the buffer area to be at atmospheric pressure. Further, this nozzle (4) may according to the embodiments for example consist simply in a perforation of the wall of the device (1) or in a pipe extending towards the outside of the cages (7), for example up to a recovery device or a collecting tank. Thus this nozzle (4) also forms a means for maintaining the liquid level of the buffer area below a threshold, regardless of the adjusted flow rate and allows discharge of the liquid towards the outside, in the case of an overfill of the buffer area, for example upon a leak from the flow rate adjustment means (5) or upon insufficient consumption of liquid by the animals between two openings of the solenoid valve (8). Further, in one embodiment, the watering device (1) may include a buffer area which may be disassembled, for example consisting in a tank which may be disassembled and replaced so as to be adapted to the different kinds of animals which may be present in the cages (7). Thus, the capacity of the buffer area between the pipette (3) and the nozzle (4) may be changed at a lower cost, depending on the animal species to be watered, without having to change the whole device.

In one embodiment, the means (5) for adjusting the flow rate entering the buffer area is produced by an adjustment device (5) such as a needle valve for example, screwed into a tapped hole (50) made on the outer surface of the buffer area. In another embodiment, the means (5) for adjusting the flow rate entering the buffer area may be produced by a membrane adjustment device, including at least a passage for the fluid in is which at least two membranes are placed, at least one of which is mobile and displaceable in the direction of the other, under the action of an adjustment screw accessible from the outside, so as to more or less block said passage opening out into an inlet conduit of the watering device through which the liquid emerges in the buffer area. The membranes of the membrane adjustment device may be flexible, in a particularly advantageous embodiment, so as to provide fine adjustment of the flow rate. The term “needle valve” (5) will be used here for designating any type of flow rate adjustment means (5) because this embodiment is the simplest but it should be obvious that the embodiments of this adjustment means are only given as an illustration and that any type of adjustment means (5) with which the flow rate entering the buffer area may be adjusted in a sufficiently accurate way, may be used without departing from the scope of the invention.

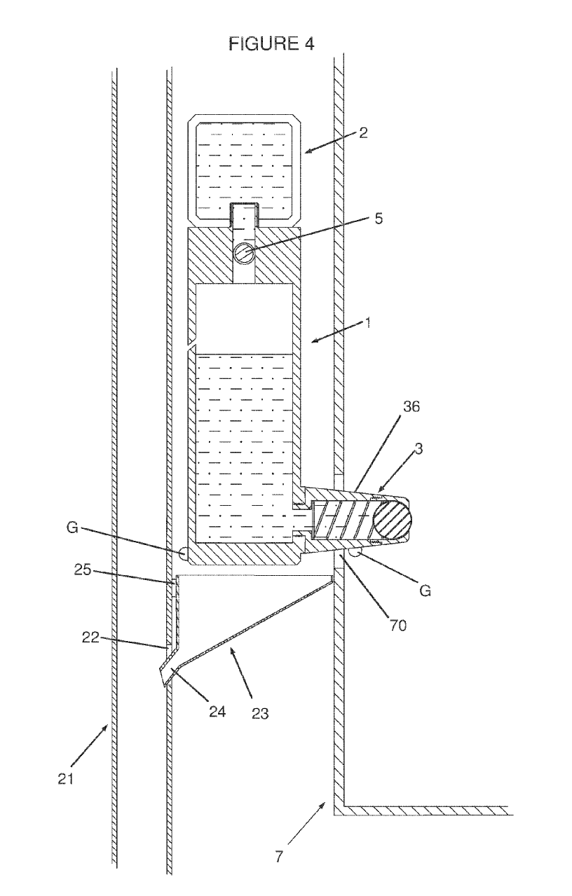

This adjustment device (5) or needle valve (5) is therefore placed in order to be accessible from the outside, for example as illustrated in FIG. 1. Of course, the position of the needle valve (5) and of the nozzle (4) may vary in height and laterally depending on the desired positioning and on the arrangement within the set (6) of cages (7), as visible for example upon comparing FIGS. 2 and 3 with FIG. 4. The needle valve (5) opens out into an inlet conduit (11) of the watering device (1) through which the liquid emerges into the buffer area. The needle valve (5) is provided with a seal gasket (52) in order to avoid leaks of liquid from the inlet conduit and, depending on the screwing down, the needle valve (5) totally or partly blocks this inlet conduit (11). Of course, the thread and the tapped thread of the needle valve (5) and of the hole (50), respectively, may have been provided so that the travel of the needle valve extends between a position where it does not block the conduit (11) at all and a position where it blocks it completely.

In one embodiment, the watering device (1) is provided with a so-called universal pipette. This pipette (3) is said to be universal because it allows the watering of animals of any kinds and of any ages. This pipette (3) includes a body comprising two ends, a first end of which is formed by an inlet tube (34) opening out onto a main tube, the inner diameter of which is larger than that of the inlet tube. The thereby formed shoulder between both of these tubes forms a seat (33) on which a spring (30) is positioned which pushes back a ball (31) mounted in the main tube towards the second end of the pipette (3). In a particularly advantageous embodiment, the spring (30) and its seat (33) has an inner diameter which is larger than the inner diameter of the inlet tube (34) of the pipette (3), which produces a continuous stream of liquid between the inlet of the pipette and outlet. The ball (31) and the spring (30) are free in the main tube and have dimensions substantially identical with those of the main tube. The second end of the pipette (3), i.e. the outlet end, includes a housing, a so-called ball seat (32), with a shape and dimensions mating those of the ball (31) and opening out onto the outside. The ball (31) is held in its ball seat (32) by the spring (30) compressed between the ball (31) and the seat (33) of the spring. Thus, when an animal wants to drink, it only has to lick or slightly push the end of the pipette, which has the effect of moving the ball (31) in translation or in rotation and allows the water to slowly flow through the thin space between the outer surface of the ball (31) and the inner surface of the seat (32) of the ball (31) and possibly by the pump effect exerted by the ball (31) in the body of the pipette (3), when the animal pushes the ball (31) and/or when the ball (31) returns back to its position under the effect of the spring. This effect facilitates watering of the animals notably when the buffer area has been emptied and when it is being refilled, because the animals actuate this kind of pump, so that the possible air bubbles may be discharged and the liquid may flow right up to the level of the ball. In the rest position, the spring pushes the ball (31) into its seat (32) and closes the pipette but it is frequent that a drop remains suspended on the end of the pipette (3), which facilitates adaptation of the animals to this type of trough.

In one embodiment, the ball seat (32) is attached onto the main tube of the pipette (3) by cooperation (35) between a thread of the main tube and a tapped thread of the ball seat (32) or vice versa. This removable attachment allows easy mounting and easy replacement of the spring (30) or of the ball (31) and allows production costs to be minimized.

In one embodiment, the inner diameters of the inlet tube (34) of the pipette (3) and of the aperture of the ball seat (32) towards the outside have substantially the same dimensions. As mentioned earlier, with these shapes and inner dimensions of the pipette, the water may form a continuous stream inside which flows perfectly when the ball (31) is displaced in translation or in rotation.

The watering device (1) includes, in proximity to its upper end, an upper inlet conduit (11) for the liquid which may be blocked by the flow rate adjustment means (5), as mentioned earlier. In one embodiment, this inlet conduit (11) is provided with a means for attachment and connection to the duct (2). This means for connecting and attaching the watering device (1) to the duct (2) is a tube (12) threaded on its outer surface, extending the inlet conduit (11) and intended to cooperate with a corresponding tapped hole (20) present on the feeding duct (2). According to the embodiment, the tube (12) for attaching the watering device (1) to the feeding duct (2) may be positioned vertically, the watering device (1) being then attached under the feeding duct (2), may be positioned horizontally, the watering device (1) being attached onto a side wall of the feeding duct (2), or form with the longitudinal axis of the buffer area, an angle comprised between 0° and 90°. Two of these embodiments are illustrated in FIGS. 2 and 3. In one embodiment of the invention, the connection of the watering device to the duct may include a flexible tube with which the watering device may be positioned anywhere in the cage relatively to the duct. Further, the means for connecting and attaching the watering device (1) to the duct (2) may be provided with a fast connector facilitating assembly and disassembly of this connecting means on the duct (2). Likewise, the flexible tube may be provided with a fast connector, at one of its ends or at both of them, in order to facilitate its connection to the duct (2) on the one hand, and/or to the watering device (1) on the other hand.

In one embodiment, a filter is interposed between the duct (2) and the upper inlet conduit (11) for the liquid, so that the liquid which penetrates into the buffer area of the watering device (1) is filtered. This filter may be an absolute filter, so that the liquid penetrating into the buffer area of the watering device (1) is sterile. Further, in one embodiment, an anti-return system may be interposed between the duct (2) and the watering device (1), in order to maintain pressure in the duct (2) and avoid its emptying. This anti-return system or device may for example be positioned between the duct (2) and the flow rate adjustment means (5).

The watering device (1) in proximity to its lower end includes a lower conduit (10) for outflow of the liquid, this lower conduit (10) communicating with the pipette (3) and including a means for attaching and connecting the watering pipette (3). In one embodiment, the means for attaching and connecting the watering pipette (3) consists in a tapped bore (100) intended to cooperate with an inlet tube (34) of the pipette (3), threaded on its outer surface, so as to allow attachment of the watering pipette (3) onto the watering device (1). This tapped ball (100) may be with a horizontal axis as illustrated in the figures or be with a vertical axis or still with an oblique axis relatively to the longitudinal axis of the buffer area, both axes forming an angle comprised between 0° and 90°.

The flow rate adjustment means (5) may, according to the selected embodiments, deliver a flow as drops or a continuous trickle, although with dripping, risks of contamination of the water network may be avoided. In order to increase the flow rate at the adjustment means (5), the choice may be made of using, instead of a single drop system in which the drops are delivered one by one, a multi-drop system in which the outlet of the adjustment means (5) (opening out into the buffer area) will include a device having a plurality of holes, like a strainer, so as to deliver several drops at the same time. Such a multi-drop system has the advantage of allowing a higher flow rate to be delivered than would allow a single drop at a time, while maintaining the discontinuity between the buffer area and the network upstream. The use of a continuous water trickle may however be chosen because germs capable of moving up a current are rare and they may be stopped by the presence of an absolute filter upstream from the flow rate is adjustment means (5). Preferably, the continuous stream will therefore be routinely associated with an absolute filter so as to avoid any contamination of the network by germs capable of moving up this stream. This flow rate adjustment means (5) may naturally be calibrated and graduated although those which are conventionally used include a number of turns preventing any effective graduation. The adjustment will therefore be more or less easy depending on the adjustment means type (5), such as a needle valve (5) or a membrane adjustment device (5) for example, whether it is a single-drop or multi-drop system. The system includes elements which may be disassembled and the means (5) for adjusting the watering devices (1) may be tested by disassembling the buffer area and replacing it with a graduated test tube or a burette or any other graduated container. Thus, the efficiency of the system may be easily tested during operation in order to check the amounts effectively delivered during one or more openings of the solenoid valve (8). Also, the solenoid valves often have a so-called continuous position, in which they remain permanently open. This property may be used for testing the system without disassembling it. Indeed, for this, it is sufficient to empty the buffer areas of the devices and to set the valve into the open continuous position and to wait for the determined time of normal opening of the valve in order to see the side nozzle (4) drip which expresses an overflow of the buffer area. If the nozzle (4) starts to drip at the end of the determined time, the device operates properly whereas if it drips before the time has elapsed, this means that the flow rate is too great and that the flow rate adjustment means (5) has to be adjusted or the device (1) has to be checked and if the nozzle does not drip at all, this means that the device (1) is blocked and that it has to be checked.

The system of FIG. 1 can possibly use other types of pipette known from the prior art, but some of the pipettes known from the prior art are not adapted to the present invention because they require liquid pressure above atmospheric pressure. However, certain pipettes from the prior art may operate at atmospheric pressure and may be used although there are risks of leaks because they do not include sealing means such as the one achieved by this spring (30) of the pipette (3) described here, which is particularly efficient.

With the system of FIG. 1, it is possible to have only one programmer (9) for a set of cages (7) but provision is also made so that several programmers (controlling several solenoid valves) may be used in parallel for watering the animals, for example when the system is intended to feed a large number of cages or when the different animals have very different daily consumptions. Also, the system of FIG. 1 can use the watering devices (1) having different sizes and therefore their buffer areas have different capacities, so that different watering devices (1) may be used and may deliver amounts adapted to the consumption of the animals. The flow rate adjustment means (5) of these devices of different sizes may also have different ranges of flow rate so as to guarantee adequate filling of the buffer area. Thus, the opening time of the solenoid valve, i.e. the duration of the water distributions during the day may be adapted to the size of the buffer area of the fed devices (1) and to the flow rate range of the adjustment means (5) of these devices (1) or be adapted to the sizes of the buffer areas and to the ranges of flow rates, in the case of the use of watering devices (1) of different sizes.

As an illustration, we shall now show an example of programming volumes of water to be distributed for a set (6) of five cages (7) each requiring a different daily volume of water, for example because they contain different animals or a different number of animals. This simple example provides an illustration of the system of FIG. 1 during operation, although the latter allows more complex configurations and proves to be particularly useful in these complex cases. For example, the person in charge of the watering of the animals may configure the programmer (9) for delivering every hour an amount of water which the animals need and thereby distribute the required daily amount over 24 hours, i.e. over 24 openings of the solenoid valve.

| Set of cages: | 1 | 2 | 3 | 4 | 5 |
|---|---|---|---|---|---|
| Desired daily volume (ml/cage): | 20 | 30 | 40 | 80 | 100 |
| Buffer area capacity: | 5 | 5 | 5 | 5 | 5 |
| Number of daily distributions: | 24 | 24 | 24 | 24 | 24 |
| Duration of a distribution (min): | 3 | 3 | 3 | 3 | 3 |
| Adjustment to the flow rate: | 10 | 12 | 15 | 30 | 40 = |
| (drop/min; 1 drop ~0.04 ml) | | | | | 60 |
| | | | | | me |
| Obtained volume per opening (ml): | 1.2 | 1.4 | 1.8 | 3.6 | 4.8 |
| Daily distributed volume (ml/cage): | 28.8 | 34.6 | 43.2 | 86.4 | 115.2 |

It is therefore understood that by adjusting regular openings of the solenoid valve (8) and by adjusting the flow rate at the inlet of the buffer area, the system allows delivery to the animals of amounts of water required at the moment when they need them. The programmer (9) may be configured so that only a part or the whole of the parameters may be entered and the result per cage may be displayed or even be configured for automatically calculating the best adjustment while requiring input of a restricted number of parameters.

In certain embodiments, the system includes a safety device, protecting the animals against floodings of their cage. This safety device may in fact include several devices which are complementary to each other. A first safety means may be achieved in certain embodiments by the outer shape of the pipette (3). Indeed, in these embodiments, the outer surface (36) of the body of the pipette (3) is frusto-conical, the diameter of the body at the second end of the body being smaller than its diameter at the first end. Thus, when the watering device (1) is attached, and is outside the cage as illustrated in FIG. 4, with the frusto-conical shape of the body of the pipette (3), possible drops (G) of liquid exiting the pipette may flow along the slope described by the outer surface (36) of the pipette body (3), as far as the outside of the cage (7). It will be understood that other embodiments of the pipette body may have the same effect and that it is not required that the whole outer surface of the pipette be frusto-conical. In certain alternative embodiments, at least one lower portion of the outer surface of the pipette body (3) will form a slope guiding the drops (G) towards the outside of the cage (7) and it will be considered here that the frusto-conical term extends to this type of alternatives. More advantageously, when the watering device (1) is attached and outside the cage as illustrated in FIG. 4, the cage (7) may include in its wall a hole (70) with a diameter substantially larger than the diameter of the body of the pipette (3) and through which the latter penetrates into the cage (7). This hole (70) is intended for letting through the pipette body but it may be provided for allowing drops to pass through, sliding on the frusto-conical pipette body up as far as the outside of the cage. This hole (70) may for example be substantially oblong or include an enlargement on its lower portion so as to let through the drops. Thus, this hole may be part of the safety device and may cooperate with the frusto-conical body in order to ensure that the drops escaping from the pipette are discharged towards the outside. Also, as mentioned earlier, a recovery device or a collecting tank may be provided in the system, notably for collecting the possible drops (G) which may have leaked out from the vent or nozzle (4) of the watering device (1) (either via a pipe or not), but also for collecting the drops which may have leaked out from the pipette and which would have flowed down the slope of the lower surface of the pipette. The safety device may therefore include in certain embodiments, a recovery device (23) positioned under the watering device (1). This recovery device will collect the discharged drops (G) and may guide them towards a discharge pipe and/or a collecting tank. In certain alternative embodiments, this recovery device (23) may include a gutter positioned under the watering device (1) and forming a slope relatively to the horizontal. The low end of the gutter may open out into a discharge pipe (21) allowing liquid to be collected (or directly into a collecting tank). In an alternative embodiment, the dimensions of the gutter will be larger than the dimensions of at least one lower end of the watering device (1), so that the drops (G) may fall from/to any location of the device (1).

It is obvious that the system of FIG. 1 may include devices for recovering liquid under many other forms or even that the safety device does not include any collecting device insofar that the safety device guides the drops sufficiently away from the cages so that they do not fall therein nor in the cages located at a lower level. In certain embodiments, the recovery device (23) has a substantially funnel shape including a flared portion positioned under the watering device (1) and a discharge end opening out into a discharge pipe (21) allowing liquid to be collected, as this is particularly visible in FIG. 4. It will be noted that the recovery device (23) looks like a funnel but its shape is laid out so as to be fitted onto the discharge pipe, or may even conform with at least partly the shape of the discharge pipe. This recovery device (23) may of course include a flared portion and a discharge end (24) without however having a funnel shape. More advantageously, the recovery device (23) may be attached to the discharge pipe (21), for example by means of a collar or tabs (25) forming a clamp allowing the recovery device (23) to be snapped onto the discharge pipe (21). Thus, in one embodiment, the discharge end of the recovery device (23) is inserted into a hole (22) of the wall of the discharge pipe (21) and by tilting the recovery device (23) towards the pipe (21), the tabs (25) may be snapped onto the pipe (21). In certain embodiments, the flared portion of the recovery device (23) has a diameter substantially larger than the dimensions of at least one lower end of the watering device (1). Thus, with the recovery device (23), the drops (G) which would fall from the device (1) may be collected at any location below the latter. In other alternatives, the recovery device (23) may include a portion coming into contact with at least one portion of the lower surface of the device (1) in order to allow the drops to move down into the recovery device (23). The discharge end (24) of the recovery device (23) may naturally consist in a pipe opening out into the discharge pipe (21) or directly into a collecting tank.

The present description discloses many embodiments described independently of each other but it should be obvious that they may be combined together insofar that they are not incompatible and that the invention is not limited to the sole examples provided here.

It should be obvious to a person of ordinary skill in the art that the is present invention allows embodiments in many other specific forms without departing from the field of application of the invention as claimed. Consequently, the present embodiments should be considered as an illustration, but they may be changed in the field defined by the scope of the appended claims, and the invention should not be limited to the details given above.

1. A programmed intermittent automatic watering system for feeding liquid to at least one cage or set of cages, including at least one duct for feeding liquid to at least one automatic watering device for animals, the watering device comprising a watering pipette accessible to the animals, a buffer area interposed between the pipette and the duct and a flow rate adjustment means interposed between the duct and the buffer area, means of the buffer area providing an air space communicating with outside of the device, a discontinuity between the volume of liquid contained in the buffer area and the liquid contained in the duct, the duct including at least one solenoid valve controlled by at least one programmer for generating, for opening and/or closing the solenoid valve, pulses at programmed intervals and durations depending on the volume of the buffer area and on a range of flow rates of the flow rate adjustment means of each of the watering devices, the flow rate adjustment means and the opening times of the solenoid valves being adapted to each other depending on the maximum amount of liquid to be delivered, and adjusted for delivering a determined amount of liquid to each of the watering devices upon each opening of the solenoid valve, the buffer area of the watering devices having a volume larger than the determined amount.

2. The system according to claim 1, wherein the programmer includes input and display means for programming/checking the durations and intervals of the pulses.

3. The system according to claim 1, wherein the programmer includes display resources for checking the durations and intervals of the programmed pulses.

4. The system according to claim 1, wherein the buffer area includes a means for maintaining the level of liquid of the buffer area below a threshold, regardless of the adjusted flow rate.

5. The system according to claim 4, wherein the means for maintaining the level of liquid of the buffer area below a threshold, includes a nozzle on a casing of the watering device, located above the buffer area and at a determined distance from a lower orifice, depending on the desired useful volume of the buffer area, the nozzle also forming the communication of the air space with the outside of the watering device for causing the buffer area to be at atmospheric pressure and allowing discharge of the liquid towards the outside in the case of overfill of the buffer area.

6. The system according to claim 1, wherein the means for adjusting the flow rate entering the buffer area includes a needle valve inserted into a tapped hole on the outer surface of the buffer area and opening out into an inlet conduit of the watering device through which the liquid opens out into the buffer area, the needle valve including a seal gasket and totally or partly blocking the inlet conduit.

7. The system according to claim 1, wherein the means for adjusting the flow rate entering the buffer area includes an adjustment device with membranes, including at least one passage for the fluid, the passage including at least two membranes, at least one of which is mobile and displaceable in the direction of the other one under the action of an adjustment screw accessible from the outside, so as to selectively block said passage opening out into an inlet conduit of the watering device through which the liquid opens out into the buffer area.

8. The system according to claim 7, wherein the membranes of the adjustment device with membranes are flexible, so as to provide fine adjustment of the flow rate.

9. The system according to claim 1, wherein the pipette includes a body comprising two ends, a first end of which is an inlet tube opening out on a main tube, the inner diameter of which is larger than that of the inlet tube, a shoulder between both of these tubes thereby forming a seat on which a spring is for pushing a ball towards a second end of the pipette, the ball and spring being free in the main tube and having dimensions substantially identical with those of the main tube, the second end of the pipette including a housing, a ball seat, with a shape and dimensions mating those of the ball, opening out onto the outside and in which the ball is held by the spring.

10. The system according to claim 9, wherein the ball seat is attached to the main tube of the pipette by cooperation between a thread of the main tube and a tapped thread of the ball seat or vice versa.

11. The system according to claim 10, wherein the inner diameters of the inlet tube of the pipette and of an aperture of the ball seat towards the outside have substantially the same dimensions.

12. The system according to claim 1, wherein the watering device includes, in proximity to its upper end, an upper inlet conduit for the liquid which is arranged to be selectively blocked by the flow rate adjuster and which includes resources for attachment and connection to the duct.

13. The system according to claim 1, wherein a filter is between the duct and the watering device, for filtering the liquid penetrating into the buffer area of the watering device.

14. The system according to claim 1, further including an anti-return system between the duct and the watering device in order to maintain pressure in the duct and avoids its emptying.

15. The system according to claim 13, wherein the filter is an absolute filter, so that the liquid penetrating the buffer area of the watering device is sterile.

16. The system according to claim 12, wherein the resources for connection and attaching the watering device to the duct include a tube threaded on its outer surface, extending the inlet conduit and cooperating with a corresponding tapped hole on the feeding duct.

17. The system according to claim 16, wherein the tube for attaching the watering device to the duct has an angle of between 0° and 90° with the longitudinal axis of the buffer area.

18. The system according to claim 16, wherein the tube for attaching the watering device to the duct is positioned vertically, the watering device being attached under the feeding duct.

19. The system according to claim 16, wherein the tube for attaching the watering device to the duct is positioned horizontally, the watering device being attached a side wall of the feeding duct.

20. The system according to claim 1, wherein the watering device includes in proximity to its lower end a lower conduit for outflow of the liquid, the lower conduit communicating with the pipette and including resources for attaching and connecting to the watering pipette.

21. The system according to claim 20, wherein the resources for attaching and connecting to the watering pipette include a tapped bore for cooperation with an inlet tube of the pipette, threaded on its outer surface, so as to allow attachment of the watering pipette on to the watering device.

22. The system according to claim 20, wherein the position of the watering pipette by the resources for attaching and connecting of the watering pipette is adapted to animal species to be watered.

23. The system according to claim 21, wherein the tapped bore has a horizontal axis.

24. The system according to claim 21, wherein the tapped bore has a vertical axis.

25. The system according to claim 21, the tapped bore has an oblique axis relative to the longitudinal axis of the buffer area, both axes being at an angle between 0° and 90° relative to each other.

26. The system according to claim 9, wherein the pipette has a frusto-conical outer surface, the diameter of the body at the second end of the body being smaller than its diameter at the first end.

27. The system according to claim 1, wherein the cage includes a wall having a hole with a diameter substantially larger than the diameter of the body of the pipette and through which the latter penetrates into the cage.

28. The system according to claim 1, further including a recovery device under the watering device.

29. The system according to claim 28, wherein the recovery device substantially has a substantial funnel shape including a flared portion under the watering device and a discharge end opening out into a discharge pipe for collecting liquid.

30. The system according to claim 29, wherein the flared portion of the recovery device has a diameter substantially larger than the dimensions of at least one lower end of the watering device.

31. The system according to claim 28, wherein the recovery device includes a gutter under the watering device, the gutter having a slope relative to the horizontal and a lower end which opens out into a discharge pipe for collecting liquid.

32. The system according to claim 30, wherein the dimensions of the gutter are larger than the dimensions of at least one lower end of the watering device.

33. An automatic system for intermittently feeding liquid to plural animal containment cages comprising a duct for feeding the liquid to a liquid dispensing device for the animal or animals in each of the cages, each of the dispensing devices including: (a) in the lower portion thereof a liquid dispensing pipette for supplying the liquid to the animal or animals in the cage, (b) in the upper portion thereof a liquid flow rate adjuster in fluid flow relationship with liquid in the duct, and (c) a buffer between the pipette and an outlet of the flow rate adjuster; the duct including a signal controlled liquid flow controller connected to be responsive to an output signal of a signal source so that, during normal operation with the animal or animals in the cages, the output signal causes the signal controlled liquid flow controller to intermittently feed liquid in the duct to the dispensing devices; the output signal and the signal controlled liquid flow controller being such that the volume of liquid fed via the duct to the dispensers by the signal controlled liquid flow controller during each intermittent liquid feed depends on: (a) time interval between adjacent feeds, (b) flow rates of the flow rate adjusters, (c) volumes of the buffers, and (d) the buffers never being filled with the liquid so an airspace is always in the buffers.

34. The system of claim 33 wherein the each of the dispensing devices includes an opening for admitting atmospheric air and pressure into the buffer above the pipette and below the outlet of the flow rate controller, the opening also being an overflow for liquid in the buffer, if necessary.

35. A method of controlling a system for intermittently feeding liquid to plural animal containment cages, the system including a duct for feeding liquid to a liquid dispensing device for the animal or animals in each of the cages, each of the dispensing devices including: (a) in the lower portion thereof a liquid dispensing pipette for supplying the liquid to the animal or animals in the cage, (b) in the upper portion thereof a liquid flow rate adjuster in fluid flow relationship with liquid in the duct, and (c) a buffer between the pipette and an outlet of the flow rate adjuster; the method comprising: simultaneously intermittently feeding the liquid to the dispensers via the duct; setting flow rate of each flow rate adjuster so a correct amount of liquid is delivered to the animal or animals in each cage during each feed of the liquid via the duct; and controlling volume of liquid fed to the dispensers via the duct during each intermittent feed so that, during normal operation with the animal or animals in the cages, the volume of liquid fed through the duct to the dispensers during each intermittent liquid feed depends on: (a) time interval between adjacent feeds, (b) flow rates of the flow rate adjusters, (c) volumes of the buffers, and (d) the buffers never being filled with the liquid so an airspace is always in the buffers.
